(19) United States
(12) Patent Application Publication
(10) Pub. No.: US 2010/0062241 A1
(43) Pub. Date: Mar. 11, 2010

(54) THERMO-ACOUSTIC RADIANT MEMBRANE

(75) Inventor: Robert Ducharme, St-Anne-Des-Plaines (CA)

Correspondence Address: DARBY & DARBY P.C., P.O. BOX 770, Church Street Station, New York, NY, 10008-0770, US

(73) Assignee: SOPREMA INC., DRUMMONDVILLE (CA)

(21) Appl. No.: 12/302,952

(22) PCT Filed: Apr. 27, 2007
(86) PCT No.: PCT/CA2007/000723

§ 371 Date: Dec. 2, 2008

(30) Foreign Application Priority Data
May 30, 2006 (CA) 2548655

(51) Int. Cl. B32B 11/02; B32B 5/16; B32B 37/26; B32B 37/10; B32B 11/08; B32B 15/16; B32B 27/14

(52) U.S. Cl. 428/327; 156/276; 156/221

(57) ABSTRACT

The thermo-acoustic radiant membrane is designed for use on a floor beneath a spa, whirlpool or therapeutic bath, inertia base or similar. The membrane comprises a radiant layer made of a metallic film, on which a layer of rubber granules of varying size are hot-laminated with a bitumen elastomer to which other components can be added such as wood, mineral, synthetic, or vegetable fibres. The membrane is also provided with a water-impermeable layer to act as a vapour block. Said layer is made from polyethylene, polypropylene, polyester or metal is resistant to tearing, static crushing and tension and has a large capacity for stretching and is covered with bitumen elastomer. The bitumen elastomer layer on the water-impermeable layer is placed on the granule layer of the radiant layer in order to assemble the membrane by adhesion of the layers.

### CROSS REFERENCE TO PRIOR APPLICATIONS

This is a U.S. National Phase application under 35 U.S.C. §371 of International Patent Application No. PCT/CA2007/000723, filed Apr. 27, 2007, and claims the benefit of Canadian Patent Application No. 2,548,655, filed May 30, 2006 both of which are incorporated by reference herein.

### FIELD OF THE INVENTION

The present invention relates to a thermo-acoustic radiant membrane, which absorbs vibrations and is specifically designed to be beneath a spa, whirlpool, a therapeutic bath, an inertia base or any other object of the same type.

### DESCRIPTION OF THE PRIOR ART

The PCT application published under number WO 2006/005164 A1 in the name of the Applicant describes a thermo-acoustic radiant membrane, comprising one or more support layers of polyethylene, polypropylene, polyester or metal such as aluminium, bronze, copper, on which or in between which is laminated a layer of rubber granules of sizes ranging from 2 to 30 mesh, resulting from scrap tires or others. Fibrous components such as wood fibres, mineral fibres, synthetic fibres or vegetable fibres can be laminated or mixed with the granules to ensure a better adherence of the latter on the membrane.

In practice, rubber granules and/or fibres are hot fixed to the base layer with bitumen elastomer and/or latex and/or polyurethane. The thickness of the granules laminate on the layer is ⅛″ to ⅝″ (about 3 mm to 16 mm).

The rubber granules and/or fibres can be deposited on the surface of the support layer or just on part of it, which has then a form of a checkerboard with a part without granules and a part with granules. Granules can also be arranged in rows, the rows of granules being for example 6 inches (15 cm), intermediate rows being 2 inches (5 cm). The width and distance of the rows or the layout in checkerboard may of course vary depending on needs.

The membrane described in this PCT application is essentially destined to be on a floor, under a concrete cover, under a lightweight self-levelling cement cover or under a sheet of plywood. Once installed, the membrane provides a suspension to the floor, in addition to a thermal, radiant and acoustic optimization of this floor.

In practice, it acts like a spring between the finished floor and its structure.

The membrane described in this PCT application is for use in residential construction and may be adapted to all wood, concrete and metal structures. It can also receive a variety of finished floor such as wood, ceramic or other. Its main role is soundproofing the floor against impact noise while being radiant.

However, this membrane is not designed to be installed in wet areas, while still having elastic, radiant, acoustic, anti-fungus and vapour block properties and being able to reduce vibrations caused by impacts of human or mechanical nature or and support important charges.

### SUMMARY OF THE INVENTION

The present invention relates to a thermo-acoustic radiant membrane that meets the supplementary needs listed above. More specifically, this invention relates to a thermo-acoustic radiant membrane installable under an element to disengage this element from a floor on which it is installed, this membrane comprising:
a) a radiant upper layer consisting of a metallic film provided with a lower surface coated with a layer of bitumen elastomer on which is laminated a layer of rubber granules; and
b) a bottom layer provided with a top surface also coated with a layer of bitumen elastomer, the top surface being laminated on the layer of granules opposite to the radiant upper layer, characterized in that:
   the layer of granules laminated on the lower surface of the radiant upper layer having a thickness of ⅛″ to ⅝″ (about 3 mm to 16 mm);
   the rubber granules of the granules layer laminated on the lower surface of the radiant upper layer having a size ranging from 2 to 30 mesh; and
a) the bottom layer is selected so as to be water-impermeable to act as a vapour block, also be resistant to tearing, static crushing and to tension, and to have a large capacity for stretching.

Preferably the water-impermeable layer is made of polyethylene, of polypropylene, polyester or metal, and the radiant layer is reinforced with a canvas.

Preferably also, fibrous components chosen from among wood fibres, mineral fibres, synthetic fibres or vegetable fibre can be mixed with the granules of the granules layer, or be laminated on it.

An object of the invention is also a manufacturing process of a thermo-acoustic radiant membrane, characterized in that it includes the following steps:
deposit of a bitumen elastomer layer on a radiant layer consisting of a metallic film;
laminating a layer of rubber granules of size ranging from 2 to 30 mesh on a layer of bitumen polymer deposited on the metallic film, the granules being deposited to form a layer having a thickness from ⅛″ to ⅝″ (about 3 mm 16 mm);
deposit a bitumen elastomer layer on a water-impermeable layer, and resistant to tearing, static crushing, tension and having a large capacity for stretching; and
placing the bitumen elastomer layer of the water-impermeable layer on the layer of granules of the radiant layer to assemble the membrane by adhesion of the layers.

Preferably, the assembly is done by calendering with heating at least one of the layers of the membrane in order to improve their adherence.

The invention and its various advantages will be better understood from the following non-restrictive description of a preferred embodiment.

### BRIEF DESCRIPTION OF THE DRAWINGS

FIG. 1 is a perspective view of the radiant layer of the thermo-acoustic radiant membrane according to the preferred embodiment of the invention.

FIG. 2 is a perspective view of the layer of rubber granules laminated on the radiant layer illustrated in FIG. 1.

FIG. 3 is a perspective view of the water-impermeable layer of the thermo-acoustic radiant membrane according to the preferred embodiment of the invention.

FIG. 4 is a perspective view of the bitumen elastomer layer deposited on the water-impermeable layer shown in FIG. 3, this FIG. 4 showing a protective silicon film partly raised.

FIG. 5 is a side view of the membrane once assembled, according to the preferred embodiment of the invention.

### DETAILED DESCRIPTION OF A PREFERRED EMBODIMENT OF THE INVENTION

The thermo-acoustic radiant membrane according to the invention has essentially the aim to reduce vibration caused by impacts of human or mechanical nature, to support important loads or to be installed in wet areas, while having elastic, radiant, acoustic, anti-fungal and vapour blocking properties. This membrane can be used beneath a spa unit, a whirlpool, a therapeutic bath, inertia base and others. This membrane is designed to disengage the mechanical unit of spa, whirlpool, the therapeutic bath, inertia base from the floor on which these elements are installed.

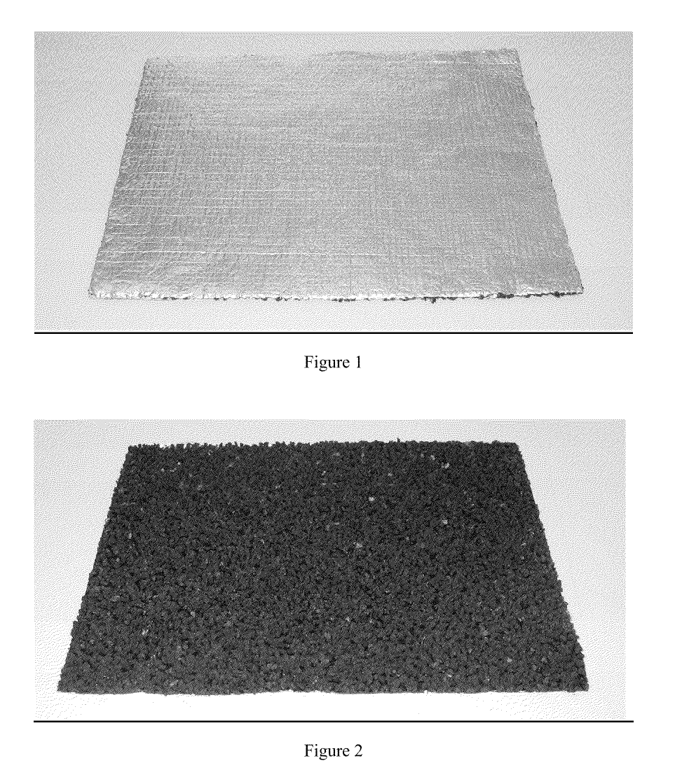

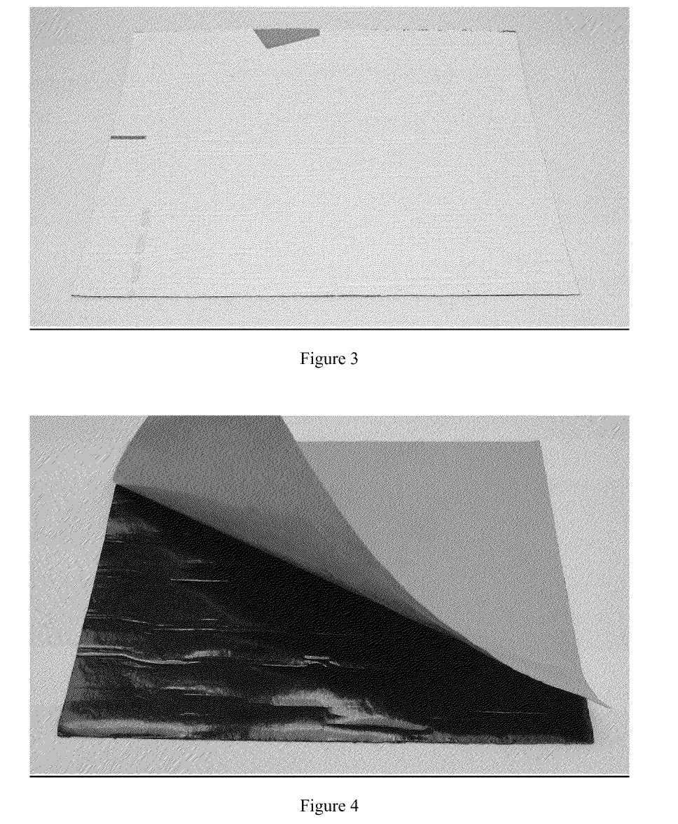

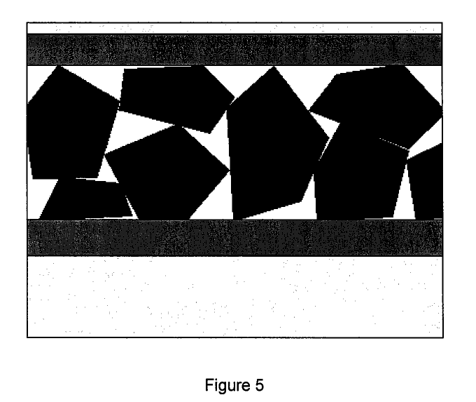

As illustrated in FIGS. 1 to 5, the membrane 1 of invention comprises a radiant layer 2 consisting of a metallic film of which one surface is coated with a layer of bitumen elastomer 3 on which a layer of rubber granules 4 of sizes ranging from 2 to 30 mesh is laminated, the layer of granules being ⅛″ to ⅝″ thick (about 3 mm to 16 mm). The membrane also includes a layer 6, which is water-impermeable to act as a vapour block, that is also resistant to tearing, to static crushing and to tension, which has a large capacity for stretching and also has a surface coated with a bitumen elastomer layer 8, this surface being laminated on the granules layer 4 opposite to the radiant layer 2.

Preferably, the layer 6 that is water-impermeable is made of polyethylene, polypropylene, polyester or metal and is covered with bitumen elastomer.

Alternatively, the layer of rubber granules 4 can be laminated on the radiant layer 2 by using hot bitumen elastomer, latex, polyurethane or a mixture thereof.

If desired, fibrous components selected from, preferably wood fibres but also mineral fibres, synthetic fibres and vegetable fibres, can be mixed with the granules or laminated on this layer.

Preferably, the radiant layer 2 is composed of aluminium, but can also be composed of copper or other material having similar properties. It is preferably reinforced with a canvas and has constant thickness preferably with a nominal value of 0.4 mm.

The manufacturing process of thermo-acoustic radiant membrane 1, is in part thermo fusion lamination. A first part of the membrane is first manufactured in the following manner. A layer of bitumen elastomer 3 is deposited on a radiant layer 2 consisting of a metallic film. Then, a layer of rubber granules of a size ranging from 2 to 30 mesh is hot laminated on the layer of bitumen elastomer which has been deposited on the metallic film, the granules being deposited to form a layer having a thickness of ⅛″ to ⅝″ (about 3 mm to 16 mm).

The second part of the membrane 1 is made in the following manner. A layer of bitumen elastomer 8 is deposited on a layer that is water-impermeable and which is resistant to tearing, to static crushing, to tension and has a large capacity for stretching. A silicon film 10 is put temporarily on the layer of bitumen elastomer 8, to prevent the deposit of contaminants that could affect its properties. This is also important to avoid its self-adhesion on the production equipment and during its winding. This film is withdrawn before the assembly of both parts of the membrane.

The assembly of both parts described above of the membrane 1 is carried out by placing the layer of bitumen elastomer 8 of the water-impermeable layer 6 on the layer of granules laminated on the bitumen elastomer 3 of the radiant layer 2. The assembly is completed by calendaring, in order for the layers to adhere together.

Preferably, at least one of the layers of the membrane is heated with hot calenders to improve their adherence.

In practice, the radiant face of the membrane must be installed facing the base of the spa, whirlpool, therapeutic bath, the inertia base and others, so that the radiation is done for example, from the spas to the membrane and from the membrane to the spas.

Preferably, the ideal size of the membrane destined for installation, is 3 feet by 5 feet (about 0.9 meters per 1.5 meters), but it can also be produced in roll of 36 inches by 26 feet (about 0.9 meters by 8 meters) or any other appropriate format.

### Example

An example of membrane according to the invention was designed and tested to withstand constant loads of 30 pounds per square inch (about 14 kg per 6.5 cm²). In this case, the water-impermeable layer 6 was formed of vapour block polyethylene with resistance to tearing, to static crushing, to tension and with a large capacity for stretching. This allowed the use of this membrane under spas of important weight.

Acoustic tests have been performed on this membrane whose radiant layer was formed of aluminium film of 0.4 mm of thickness, of which a surface was coated with a layer of bitumen elastomer on which a layer of rubber granules of about 20 mesh was laminated. The membrane comprised a layer that is water-impermeable having a nominal thickness of 1, 0 mm, and that also had a surface coated with a layer of bitumen elastomer, this surface being laminated on the layer of granules opposite of the radiant layer. No fibrous component was present in the sample studied. The acoustic tests have demonstrated that noise resulting directly from vibrations was reduced by 21 dB using the membrane instead of placing the bath directly on the deck.

It goes without saying that many changes could be to the preferred embodiment of the invention, materials and dimensions described above without departing from the scope of this invention as defined in the annexed claims.

1-7. (canceled)

8. A thermo-acoustic radiant membrane installable under an element to disengage this element from a floor on which it is installed, this membrane comprising:
a) a radiant upper layer consisting of a metallic film provided with a lower surface coated with a layer of bitumen elastomer on which is laminated a layer of rubber granules; and
b) a bottom layer provided with a top surface also coated with a layer of bitumen elastomer, the top surface being laminated on the layer of granules opposite to the radiant upper layer, characterized in that:
the layer of granules laminated on the lower surface of the radiant upper layer having a thickness of ⅛″ to ⅝″ (about 3 mm to 16 mm);
the rubber granules of the granules layer laminated on the lower surface of the radiant upper layer having a size ranging from 2 to 30 mesh; and
the bottom layer is selected so as to be water-impermeable to act as a vapour block, also be resistant to tearing, static crushing and to tension, and to have a large capacity for stretching.

9. Membrane according to claim 8, wherein the water-impermeable layer is made of polyethylene, polypropylene, polyester or metal.

10. Membrane according to claim 8, wherein fibrous components selected from wood fibres, mineral fibres, synthetic fibres and vegetable fibres are mixed with the granules of the layer of granules or laminated on said layer.

11. Membrane according to claim 8, wherein the radiant upper layer is reinforced by a canvas.

12. Membrane according to claim 8, wherein the radiant upper layer consists of a radiant aluminium film of a thickness of 0.4 mm and the bottom water-impermeable layer having a nominal thickness of 1.0 mm.

13. A process for manufacturing a thermo-acoustic radiant membrane wherein it comprises the following steps:
a) deposit of a bitumen elastomer layer on a radiant layer consisting of a metallic film;
b) laminating of a layer of rubber granules of size ranging from 2 to 30 mesh on a layer of bitumen polymer deposited on the metallic film, the granules being deposited to form a layer having a thickness from ⅛″ to ⅝″ (about 3 mm 16 mm);
c) deposit a bitumen elastomer layer on a layer that is water-impermeable, and resistant to tearing, to static crushing, to tension and having a large capacity for stretching; and
d) placing the bitumen elastomer layer of the water-impermeable layer on the layer of granules of the radiant layer to assemble the membrane by adhesion of the layers.

14. The process of claim 13, wherein step in d), the assembly is done by calendering.

15. The process according to claim 14, wherein hot calenders are used to heat at least one of the layers of the membrane to improve the adhesion of said layers.
